(19) United States
(12) Patent Application Publication
(10) Pub. No.: US 2024/0190067 A1
(43) Pub. Date: Jun. 13, 2024

(54) MATTING AGENT RESIN FOR 3D PRINTING

(71) Applicant: ARKEMA INC., King of Prussia, PA (US)

(72) Inventors: Mary K. CALVIN, King of Prussia, PA (US); Evan J. FISHER, King of Prussia, PA (US); David Shin-Ren LIU, King of Prussia, PA (US); Brian M. CROMER, King of Prussia, PA (US)

(73) Assignee: ARKEMA INC., King of Prussia, PA (US)

(21) Appl. No.: 18/550,803

(22) PCT Filed: Mar. 16, 2022
(86) PCT No.: PCT/US2022/020483

§ 371 Date: Sep. 15, 2023

Related U.S. Application Data
(60) Provisional application No. 63/162,168, filed on Mar. 17, 2021.

(51) Int. Cl. B29C 64/141; B29C 64/209; B29C 64/336; B29K 33/00; B29K 433/04; B33Y 70/00

(52) U.S. Cl. CPC B29C 64/141; B29C 64/209; B29C 64/336; B33Y 70/00; B29K 2033/12; B29K 2433/04; B29K 2995/0039; B29K 2995/0094

(57) ABSTRACT

The invention relates a resin composition containing a polymer matting agent, that improves the aesthetic appearance of an article formed by Material Extrusion 3D printing. The composition contains 30-99.9 wt % thermoplastic resin and 0.1-50 wt % of one or more spherical or near-spherical polymeric matting agents (PMAs) such as Altuglas Acryperl® beads from Arkema. Objects 3D printed from the composition have hidden layer lines (a.k.a. “build lines”) and is more uniform in appearance, compared to an object printed from the same thermoplastic resin without PMAs.

### FIELD OF THE INVENTION

The invention relates a resin composition containing a polymer matting agent, which improves the aesthetic appearance of an article formed by Material Extrusion 3D printing. The composition contains 30-99.9 wt % thermoplastic resin, 0-50 wt % impact modifier, and 0.1-50 wt % of one or more spherical or near-spherical polymeric matting agents (PMAs) such as Altuglas Acryperl® beads from Arkema. Objects 3D printed from the composition have hidden layer lines (a.k.a. “build lines”) and is more uniform in appearance, compared to an object printed from the same thermoplastic resin without PMAs.

### BACKGROUND OF THE INVENTION

Material Extrusion 3D printing includes any additive manufacturing technique that heats, extrudes and deposits thermoplastic material onto a build surface a layer at a time until the desired object results. Two common techniques within the broader category of Material Extrusion 3D printing are Fused Filament Fabrication (FFF) and Direct Pellet Extrusion (DPE). Through guidance from a computer program, material deposition follows a sequential layer-by-layer process until the said desired object results. Accordingly, thermoplastic objects formed by Material Extrusion 3D printing contain several layers stacked one over the other. In contrast to conventional polymer processing methods such as extrusion and injection molding, Material Extrusion 3D printing enables the manufacturing of complex objects not accessible by other methods and creation of objects without a mold or further machining. Fused Filament Fabrication (FFF) is currently the most popular 3D printing method for home hobbyists and is particularly useful for prototyping and rapid manufacturing of objects with complex shapes or on demand.

However, Material Extrusion 3D-printing methods also create undesirable structural artifacts in printed objects, called layer lines, which result in an aesthetically unappealing and asymmetric surface. Layer lines appear as a periodic lenticular-like pattern, where the surface gloss parallel to the orientation of the layer lines is different from the gloss perpendicular to the layer lines, producing an anisotropic appearance on the surface of the printed material. The appearance of the printed object's surface changes depending on the angle of observation, specifically whether the observer is viewing the printed object parallel or perpendicular to the layer lines. Conventional polymer processing methods such as extrusion and injection molding do not create layer lines.

In order to achieve desirable surface aesthetics, including the removal of layer lines, objects formed by material extrusion 3D printing must go through one or more secondary post-processing methods to remove and/or reduce the appearance of layer lines. Post processing methods generally involve removing or smoothing the outer layers of the printed object thereby removing the lenticular-like pattern. Useful post-processing methods include, but are not limited to, sanding, polishing, buffing, painting, coating, abrasive blasting, vapor polishing, and/or milling. Depending on the printed material, size, and object geometry, post processing operations can contribute 10-40% of the manufacturing cost of FFF 3D printing and change the mechanical properties of the as-printed part. Accordingly, a thermoplastic material for Material Extrusion 3D printing that does not require post processing to remove the appearance of layer lines and allows a part to be accepted as-printed is an industrially desirable technology for the 3D-printing industry.

Some resins for Material Extrusion 3D printing, particularly for FFF, have been formulated with one or more fillers or particulate matting agents, such as carbon fiber, glass fiber, natural fiber, calcium carbonate, or ground wood. Such fillers or particulate matting agents are generally produced through grinding/milling processes that inherently produce an irregular particle shape and/or large particle size distributions. When used in FFF, resins with these matting agents are known to clog the printer nozzle during processing, or force the operator to choose a larger nozzle and sacrifice print resolution. FFF 3D printing nozzles are generally 0.2 to 0.8 mm in diameter (0.4 mm is most common). The irregular particulate matting agents may accelerate wear and abrasion on components of the printing system such as the feeder gears and printing nozzle.

Additionally, particulate matting agents may reduce the ductility of the thermoplastic filament, creating undesirable filament fracture events during printing and printing errors. Matting agents with high aspect ratio such as fibers become oriented in the direction of extrusion during printing, and thus impart a suboptimal and anisotropic matting effect. Furthermore, particulate matting agents such as fibers, inorganic particles or wood may alter the color of the resin, and/or accelerate thermal-oxidative degradation of the thermoplastic matrix, and/or introduce an undesirable odor to the resin, either through the particle color (opaque particles), the particle chemistry, and/or the large refractive index mismatch (>0.2) relative to the thermoplastic matrix.

It is desirable to improve the aesthetic appearance of a 3D printed object, without the need for a post-processing step, and without the undesirable properties of particulate matting agents.

It has now been found that polymer matting agents (PMAs), having a spherical or near-spherical shape, can be used to produce a 3D printed object with no noticeable or reduced observable layer lines. Additionally, PMAs are inherently transparent or translucent and thus do not alter the color of thermoplastic matrix.

### SUMMARY OF THE INVENTION

The invention relates to the use of matting agents in a 3-D printed article to improve the aesthetic appearance of an article formed by Material Extrusion 3D printing. The polymer composition of the invention contains from 30 to 99.9 weight percent, preferably from 40 to 95 weight percent, more preferably 50 to 90 weight percent, even more preferably 50 to 85 weight percent of a thermoplastic polymer resin matrix, and from. 0.1 to 70 wt %, preferably 5 to 60 wt %, more preferably from 10 to 50 wt % and even more preferably from 15 to 50 wt % of a polymeric matting agent. The thermoplastic polymer resin matrix can optionally comprise 0-50 wt % of an impact modifier, preferably 0-40 wt % of an impact modifier, and more preferably 0-35 wt %.

In one preferred embodiment, the thermoplastic polymer resin matrix is an acrylonitrile-butadiene-styrene (ABS), acrylonitrile-styrene-acrylate (ASA) copolymers, styrene acrylonitrile (SAN) copolymers, polylactic acid (PLA) acrylics, glycol modified polyethylene terephthalate (PETG), polycarbonate (PC), thermoplastic polyurethane (TPU), polyamides and copolyamides, polyether-block polyamides (PEBA), polyether ether ketone (PEEK), polyether ketone ketone (PEKK), polyethylenimine (PEI), polysulfone (PSU), polyphenyl sulfone (PPSU), polyvinylidene, with amorphous polymers ABS, PMMA, PETG, ASA, PC, PLA, and PEBA being especially preferred.

The polymeric matting agent used in the polymer composition of the invention is preferably an acrylic copolymer, styrenic copolymer, acrylic/styrenic copolymer, polyamide, copolyamide, polytetrafluoroethylene (PTFE), polyvinylidene fluoride (PVDF), linear or crosslinked silicone, or silsesquioxane silicone obtained via hydrolysis and polycondensation of organotrialkoxysilanes and tetraalkoxysilanes. The polymeric matting agent preferably has an average particle size by number as determined by laser diffraction particle size analysis of from 700 nm to 200 micrometers, preferably 5 micrometers to 100 micrometers.

In one embodiment, a 3D printed article, which includes the composition of the invention, has two or more different domains of thermoplastic. By different domains is meant, that at least on characteristic in the respective domain is different, for instance one is transparent and one is opaque; they have different colors; at least one domain contains the polymeric matting agent, while another region not ect. The different domains can be the respective layers of the 3D printed article. The multi-domain article may include a multi-domain surface. For example, a first domain contains polymeric matting agents and covers all surfaces of the 3D printed article and the another domain does not contain polymeric matting agents and may not cover the surface of the object.

In another embodiment the present invention refers to a 3D printed article, wherein said article comprises two or more different domains of thermoplastic material, wherein said domains are present in the bulk of the article, and wherein said domains are also present on the surface of the printed object, where at least one of the domains is the polymer composition according to the invention. The domains are the same as defined before.

In a preferred embodiment, the polymer composition further comprises from 0 to 40 weight percent of one or more additives selected from the group consisting of impact modifiers, lubricants, dispersion agents, UV stabilizers, and colorants. Preferably the impact modifier.

The polymer composition of the invention, and an printed article including the composition comprises 30 to 99.9 weight percent of at least one thermoplastic polymer as the matrix resin, and from 0.1 to 70 weight percent polymeric matting agent, wherein said 3-D printed article has a surface gloss ratio (SGR) of from 0.5 to 10.0, preferably from 0.7 to 2.0, and more preferably from 0.8 to 1.5, as measured on a 3-D printed article without any additional post-printing treatment at an angle of 85°. Preferably the polymeric composition and article printed from that polymeric composition comprises 50 to 99.9 weight percent of at least one thermoplastic polymer as the matrix, and from 0.1 to 50 wt % polymeric matting agent, wherein said 3-D printed article has a Reflectance ratio (R) of from 0.95 to 1.05, preferably from 0.97 to 1.03, and more preferably from 0.98 to 1.02, as measured on a 3-D printed article without any additional post-printing treatment. The reflectance ratio (R) is the ratio between two measured reflectance, one measured in horizontal orientation and one measure in vertical orientation: (R)=(% R Horizontal orientation)/(% R Vertical orientation).

The invention also relates to a process for the Material Extrusion 3D printing of polymer composition of the invention. The process involves the steps of
a) feeding a material comprising the polymer composition of claim 1 into a 3D printer,
b) passing the polymer composition through a heated nozzle at the conditions controlled by a computer,
c) depositing a set amount of the polymer composition through the nozzle at a set position in relation to the article to be printed.
d) cooling the printed article.

The fed material comprises the polymer composition of the invention. If no other compounds are present, the material is the polymer composition of the invention.

In one embodiment, the process involves the printing of more than one composition, including one or more polymer compositions of the invention that either have different matting agents, different concentrations of matting agents, or both. The multi-composition process may involve multiple nozzles with different polymer compositions, or the combination of different composition in the 3D printer itself, such as in the extruder.

### DETAILED DESCRIPTION OF THE INVENTION

All references cited herein are incorporated by reference. Unless otherwise stated, all molecular weights are weight average molecular weights as determined by Gel Permeation Chromatography (GPC), and all percentages are percentage by weight.

The term “copolymer” as used herein indicates a polymer composed of two or more different monomer units, including two comonomers, terpolymers, and polymers having 3 or more different monomers. The copolymers may be random or block, may be heterogeneous or homogeneous, and may be synthesized by a batch, semi-batch or continuous process. (Meth)acrylate is used to connote both acrylates and methacrylates, as well as mixtures of these.

Polymers may be straight chain, branched, star, comb, block, or any other structure.

As used herein, the term “impact modifier” is used to mean additives that increase the durability (impact resistance, ductility) of a resin, and may include block copolymers, graft copolymers, and core-shell particles. In the case of block copolymers or graft copolymers, the impact modifier additive phase separates from the polymer matrix into elastomeric nano-domains that may adopt a number of morphologies, including spherical and worm-like. The characteristic size as of the elastomeric nano-domains as determined by Transmission Electron Microscopy (TEM) is no greater than 500 nm. In the case of core/shell particles, the impact modifier additives are spherical particles with a number average particle diameter as determined by laser diffraction particle size analysis of less than 600 nm. Core/shell impact modifiers are multi-stage, sequentially produced polymeric particles having a core/shell particle structure of at least two layers. Preferentially, the core shell-modifier comprises three layers made of a hard core layer, one or more intermediate elastomeric layers, and a hard shell layer. By the wording hard and soft, the glass transition temperature (Tg) of the respective polymeric layers are meant. Hard signifies a Tg larger than 60° C., preferably larger than 80° C., while soft signifies a Tg less than 0° C., preferably less than −20° C. The Tg is measured with dynamic differential calorimetry (differential scanning calorimetry, DSC) to according to ISO 11357-2/2013.

As used herein, Polymeric Matting agents (PMAs) are spherical particles produced by any technique, with number average particle diameter as determined by laser diffraction particle size analysis of greater than 300 nm, preferably greater than 700 nm. PMAs may be produced by emulsion or suspension polymerization, they may be, but are not necessarily layered particles produced by two or more stages. The purpose of these larger particles is to provide a rough or matt surface on articles formed from the composition.

Impact modifiers and polymer matting agents may have the same or similar chemistry, or very different chemistry. Both impact modifiers and PMAs may or may not be RI matched to the matrix. By Refractive Index (RI) matched is meant that the refractive index difference between the particles and the matrix is within +/−0.002 units, and preferably within +/−0.001 unit. The function of the smaller impact modifier and the matting agent is different.

The invention relates to a composition for 3D printing containing a polymer matting agent in a thermoplastic resin.

### Thermoplastic Resin

The 3D printable composition of the invention contains 30 to 99.9 wt %, preferably 40 to 95 wt %, more preferably 40 to 90 wt %, still more preferably 50 to 90 wt % and even still more preferably 50 to 85 wt % of a thermoplastic polymer resin. Any thermoplastic polymer resin useful in Material Extrusion 3D-Printing, may be used, including but not limited to acrylonitrile-butadiene-styrene (ABS), acrylonitrile-styrene-acrylate (ASA) copolymers, styrene acrylonitrile (SAN) copolymers, polylactic acid (PLA) acrylics, glycol modified polyethylene terephthalate (PETG), polycarbonate (PC), thermoplastic polyurethane (TPU), polyamides and copolyamides, polyphthalamides (PPA), polyether-block polyamides (PEBA), polyvinyl alcohol (PVA), butenediol vinyl alcohol copolymers (BVOH), polyether ether ketone (PEEK), polyether ketone ketone (PEKK), polyethylenimine (PEI), polysulfone (PSU), polyphenyl sulfone (PPSU), polyvinylidene fluoride (PVDF), polyesters, copolyesters, polystyrene, polypropylene and other polyolefins and copolymers, blends and alloys of these.

Preferred thermoplastic polymer resin matrices are those that are amorphous during printing, including but not limited to ABS, PMMA, PETG, ASA, PC, PLA, and PEBA as these generally print with higher surface gloss due to the lack of crystallinity. Lack of crystallinity also includes also a kinetic approach, meaning that if the speed of the crystallization is too slow that the thermoplastic polymer does not crystallize during the printing. Preferred resins are miscible with the PMA or promote homogeneous distribution of the PMA when melt processed with the PMA.

PMMA is polymethyl methacrylate (PMMA) which refers to a homo- or copolymer of methyl methacrylate (MMA) that comprises at least 50%, preferably at least 60%, more preferably at least 70% by weight of methyl methacrylate.

### Polymeric Mating Agent (PMA)

The 3D printable composition of the invention contains 0.1 to 50 wt %, preferably 1 to 45 wt %, more preferably 5 to 30 wt % of a polymeric matting agent. Polymeric matting agents are polymeric particles that are spherical or near spherical in shape and have a mean number average particle size, as measured by Laser Diffraction Particle Size Analysis, of 0.3-200 micrometers, more preferably 0.7-200 micrometers, still more preferably 1-100 micrometers and even still more preferably 5-100 micrometers. The polymeric matting agents are made by processes known to those skilled in the art, including but not limited to emulsion polymerization, suspension polymerization, polycondensation, self-assembly/phase separation, grinding, comminution, and/or sieving. The PMAs may be monolithic or core-shell particles.

Useful polymer matting agents include, but not limited to acrylic copolymers, styrenic copolymers, acrylic/styrenic copolymers, polyamides, copolyamides, polytetrafluoro ethylene (PTFE), polyvinylidenefluoride (PVDF), and silicones (linear or organically crosslinked), or silsesquioxane silicones obtained via hydrolysis and polycondensation of organotrialkoxysilanes and/or tetraalkoxysilanes.

In one embodiment, Altuglas Acryperl® additives from Arkema are used as the matting agent. Altuglas Acryperl® additives are spherical particles of size 1-100 micrometers. By size, the number average particle size as diameter, is meant. The small bead size with narrow size distribution (relative to the size distribution created by grinding or comminution) allows for good dispersion into polymer melts during melt processing and a uniform surface appearance (gloss reduction) in the final material.

In one preferred embodiment, the PMAs are synthesized with highly entangled and/or highly cross-linked polymer architecture. This reduces the particle swelling and increases the durability. PMAs synthesized with monomer compositions resistant to solvent swelling are also preferred.

In one preferred embodiment, the PMAs are synthesized with monomer compositions that promote dispersion in the polymer matrix.

In another preferred embodiment the PMA composition is refractive index (RI) matched or slightly mis-matched to the RI of the polymer matrix. Without being bound by any particular theory, it is preferred that the difference in the refractive index between the matting agent and the polymeric matrix is as small as possible, preferably from 0 to 0.25, in order to improve the color and appearance of the printed object.

Colorless or nearly colorless PMA compositions are a preferred embodiment.

PMAs impart useful surface properties to the 3D printed article, including scratch resistance, mar resistance, abrasion resistance, gloss reduction, a rubber-soft feel, antiblocking, and reduced coefficient of friction.

In one embodiment, there is a preferred relationship between the PMA size and the layers line thickness, which is the thickness of each respective layer created by Material Extrusion 3D printing process. Without being bound to any particular theory, the PMA number average diameter should be between 0.1-70% of the thickness of the layer line, preferably 1-50%, more preferably 5-30%.

### Additives

In addition to the polymeric matrix and the matting agents, the 3D printable composition of the invention may optionally contain from 0 to 40 weight percent other additive as known in the art. Useful additives include, but not limited to impact modifiers, lubricants, dispersion agents, UV stabilizers, colorants, etc.

In one embodiment, impact modifiers are present at from 0.01 to 50 weight percent, preferably from 0.01 to 40 wt % and more preferably from 0.01 to 35 wt %, based on the entire 3D printable composition. The total 3D-printable composition of the invention contains at least 35 weight percent, preferably at least 40 weight percent, and more preferably at least 50 weight percent of the thermoplastic polymer. The total of the matting agent plus impact modifier being from 5 to 65 weight percent, preferably 15 to 60 weight percent, more preferably 25 to 50 weight percent of the total composition. The exact level of matting agent selected is based on what is needed to provide the desired aesthetic properties you want, which is related to the type and size of matting agent, and the level of impact modifier selected so the composition is flexible enough to be printed and processed.

In another embodiment, impact modifiers are present at from 0.01 to 50 weight percent, preferably from 0.01 to 40 wt % and more preferably from 0.01 to 35 wt %, based on the entire 3D printable composition that comprises PMMA as thermoplastic polymer resin matrice. The total 3D-printable composition of the invention contains at least 35 weight percent, preferably at least 40 weight percent, and more preferably at least 50 weight percent of PMMA as thermoplastic polymer. The total of the matting agent plus impact modifier being from 5 to 65 weight percent, preferably 15 to 60 weight percent, more preferably 25 to 50 weight percent of the total composition. The exact level of matting agent selected is based on what is needed to provide the desired aesthetic properties you want, which is related to the type and size of matting agent, and the level of impact modifier selected so the composition is flexible enough to be printed and processed.

### 3D Printing Process:

The polymeric composition of the invention is used as a powder or pellets, and in a preferred embodiment is formed into a filament, generally by an extrusion process.

The polymeric composition of the invention comprising the polymeric matting agent or in other words the polymeric matting agent composition will be 3D printed in a material extrusion (which may include but are not limited to fused deposition modeling or fused filament fabrication (FFF) printers) style 3D printer, with or without filaments (any size filament diameter, including 1.75 mm, 2.85 mm or other sizes), with any sized nozzle at any speed that can use filaments, pellets, powders, or other forms of the composition. Such machine could be any machine falling within the definition for either a material extrusion or a hybrid system that contains one or more material extrusion heads according to ISO/ASTM52900. The 3D printing of this invention is not a laser sintering process. The compositions can be made into filaments for such purposes.

A general description of the printing process would involve the following steps: Feeding the polymeric matting agent composition filament, pellets or powder into the 3D printer. The computer controls of the printer will be set to provide a set volume flow of material, and to space the printed lines at a certain spacing. The machine will feed the inventive composition to a heated nozzle at the set speed, the printer moving the nozzle into the proper position for depositing the set amount of the inventive composition.

The printer would feature one or more heated nozzles through which the material is extruded. These nozzles would be able to reach 200° C. (preferably 250° C., more preferably above 300° C.). The printer would feature a build environment open to ambient conditions, or be enclosed. The printer could feature additional controls such as an actively heated or cooled build environment. An actively heated build environment could be used to decrease the warpage of the object during printing. The printer could feature a radiative heating element within an open or enclosed build volume.

In one preferred embodiment, a Material Extrusion 3D printer with multiple extruders or nozzles would print different filaments with different loadings, sizes, or size distributions of polymeric matting agents to allow different amounts of matting to be applied to different regions of the model. In another embodiment, filaments or pellets of which one or more would contain polymeric matting agents would be combined within the extruder screw or nozzle at varying ratios in order to allow fine control of the level of matting within different regions of the model.

Process parameters of the 3-D printer may be adjusted to minimize shrinkage and warpage, and to produce 3-D printed parts having optimum strength and elongation. The use of selected process parameters applies to any extrusion/melt 3-D printer, and preferably to filament printing.

### Properties

The polymeric matting agent composition of the invention is especially useful for hiding layer lines of opaque objects printed by Material Extrusion 3D-Printing. This can be quantified by the Surface Gloss Ratio (SGR) as described below. The hiding of the layer lines can also be quantified by the reflectance ratio (% R ratio) as described below.

In a preferred embodiment, the surface gloss ratio (SGR) is from 0.5 to 10.0, preferably from 0.7 to 2.0, and more preferably from 0.8 to 1.5, as measured on a 3-D printed article without any additional post-printing treatment at and angel of 85°.

In a preferred embodiment the 3-D printed article of the invention has a Reflectance ratio (R) of from 0.95 to 1.05, preferably from 0.97 to 1.03, and more preferably from 0.98 to 1.02, as measured on a 3-D printed article without any additional post-printing treatment.

In a preferred embodiment, a printed 3-D article of the invention has both a surface gloss ratio (SGR) is from 0.5 to 10.0, preferably from 0.7 to 2.0, and more preferably from 0.8 to 1.5, and a Reflectance ratio (R) of from 0.95 to 1.05, preferably from 0.97 to 1.03, and more preferably from 0.98 to 1.02, as measured on a 3-D printed article without any additional post-printing treatment.

Other advantages of 3D printing with the polymeric matting agent composition of the invention include reduced clogging, equipment wear, and processing issues of Material Extrusion 3D printing during printing; desirable aesthetic appearance due to the uniform particle size distribution of PMAs; retention of the color of the underlying thermoplastic resins, with a refractive index match preferred; and desirable mechanical performance of the final thermoplastic filament, as compared to other particulate matting agents such as calcium carbonate that weaken the thermoplastic filament.

### Uses

This 3D printable thermoplastic material or preferably acrylic material which comprises the polymer composition of the invention, can be used in multiple markets including, but not limited to: automotive, building and construction, capstock, aeronautic, aerospace, photovoltaic, medical, computer-related, telecommunication, and wind energy. These applications include (but are not limited to): exterior paneling, automotive body panels, auto body trim, recreational vehicle body panels or trims, exterior panels for recreational sporting equipment, marine equipment, exterior panels for outdoor lawn, garden and agricultural equipment and exterior paneling for marine, aerospace structures, aircraft, public transportation applications, interior paneling applications, interior automotive trims, components for head and or tail lights on vehicles, prototyping, interior panels for marine equipment, interior panels for aerospace and aircraft, interior panels for public transportation applications, and paneling for appliances, furniture, and cabinets, recreational vehicle, sporting equipment, marine, aerospace, decking, railing, siding, window and door profiles, dishwasher and dryers, refrigerator and freezers, appliance housing or doors, bathtubs, shower stalls, spas, counters, and storage facilities, decorative exterior trim, molding side trim, quarter panel trim panels, fender and fender extensions, louvers, rear end panels, caps for pickup truck back, rearview mirror housings, accessories for trucks, buses, campers, vans, and mass transit vehicles, b pillar extensions, and the like; appliances and tools such as lawn and garden implements, bathroom fixtures for mobile homes, fencing, components of pleasure boats, exterior components of mobile homes, lawn furniture such as chair and table frames, pipe and pipe end caps, luggage, shower stalls for mobile homes, toilet seats, signs, spas, air conditioner and heat pump components, kitchen housewares, bead molded picnic coolers, picnic trays and jugs, and trash cans; venetian blind components; sporting goods such as sailboards, sailboats; plumbing parts such as lavatory parts and the like; construction components, in addition to those mentioned previously, the additional components including architectural moldings, door molding, louvers, and shutters, mobile home skirting, residential or commercial doors, siding accessories, window cladding, storm window frames, skylight frames, end caps for gutters, awnings, car port roofs, lamp, lighting equipment, sensor, custom carry cash for consumer items, silverware, trim for cars, prototypes, figurines, dentures, hardware, cabinet, ball-joint, hosing, glasses, cage, UV protector screen, signage, toys, medical equipment such as implants and equipment components, lighting appliques, luminaire housing, window coverings, surface modification, visualization aids 3D model based on, medical imaging, architectural models, topographic data, mathematical analysis, or other data sets. Education aids, props, costumes, park benches, robotics components, electrical enclosures, 3D printer components, jigs, fixtures, manufacturing aids, molds, sculptures, statues, board games, miniatures, dioramas, trophies, drones, UAV's, medical devices (Class I, Class II, and Class III according to FDA Code of Federal regulations Title 21), diffuser or light diffusing elements, instrumentation, solar cells, fixtures and rigging for solar power generating systems, artificial nails, dosimeters, jewelry, footwear, fabric, firearm components, cell phone cases, packaging.

### EXAMPLES

### Materials

Resin A: Acrylic copolymer containing 75 wt % methylmethacrylate co-monomer and 25 wt % ethyl(acrylate) co-monomer, RI=1.48 (n_{D} line at 589.3 nm), measured with an Abbe Refractomer
Modifier A: Core-shell impact modifier
Black color concentrate: A black color concentrate, recommended loading 2%.
Acrylic particle A: Acrylic copolymer with number average diameter, 50 micrometers and RI=1.51 (n_{D} line at 589.3 nm)
Acrylic particle B: Acrylic copolymer with number average diameter, 20 micrometer and RI=1.49 (n_{D} line at 589.3 nm)

### Processing Conditions

The materials are combined and compounded by twin screw extrusion (Leistritz ZSE-27THP), and then filament of each material was prepared using a single screw extruder.
FFF Printing was performed on an Ultimaker S3 with a 0.4 mm nozzle at 230° C. and a layer height of 0.2 mm.
2.25″×2.25″×0.125″ plaque samples of each resin were printed by FFF. The samples were printed upon the edge of the 2.25″×2.25″×0.125″ plaque. In other words, the layer-by-layer deposition initiated on the 2.25″×0.125″ edge of the sample plaque. Accordingly the broad side (the 2.25″×2.25″ surface of the 2.25″×2.25″×0.125″ plaque) is the “side” of the 3D printed object that contains the layer lines. The print was performed this way to simulate the appearance of layer lines. In this case, the layer lines are perpendicular to the normal of the printing surface
For comparison, injection molding plaques of Resins 1-6 were prepared by injection molding on a Sumitomo-DeMag injection molding machine, within a highly polished 2″×3″×0.125″ plaque mold.

### Example Resin Compositions

| | Resin | Resin | Resin | Resin | Resin | Resin |
|---|---|---|---|---|---|---|
| | 1 | 2 | 3 | 4 | 5 | 6 |
| Resin A | 75 | 61.5 | 61.5 | 73.5 | 60 | 60 |
| Core-shell Impact Modifier | 25 | 20.5 | 20.5 | 24.5 | 20 | 20 |
| Black Color Concentrate | 0 | 0 | 0 | 2 | 2 | 2 |
| Acrylic Particle A | 0 | 18 | 0 | 0 | 18 | 0 |
| Acrylic Particle B | 0 | 0 | 18 | 0 | 0 | 18 |

### Methods

Particle Size: Particle size of the PMA was measured by Laser Diffraction Particle size analysis. The average particle size is the number average particle size. The unit is a Malvern Mastersizer 2000LS.

Layer line visibility: Two measurement methods were used to quantify the visibility of layer lines: reflectance and gloss. The layer lines present on FFF printed surfaces resulted in orientation dependent reflection and gloss values, and accordingly the orientation ratio of reflectance and gloss was used to quantify layer line visibility.

Reflectance Measurement: The optical reflectance at 560 nm was measured using a Perkin Elmer Lambda 950 Spectrophotometer with 150 mm integrating sphere. Reflectance was measured parallel to the surface normal of the broad side of the 3-D printed object, a 2.25″×2.25″×0.125″ plaque. Separate reflectance measurements were captured with the layer lines oriented horizontally (HORT) and vertically (VERT) in %, relative to the surface upon which the spectrophotometer sits.

The reflectance ratio (R) also called R Orientation Ratio is calculated: (R)=(% R Horizontal orientation)/(% R Vertical orientation) also abbreviated as well as quotient (HORT/VERT) of the respective reflection in % measured with the layer lines oriented horizontally (HORT) and vertically (VERT).

Gloss measurement: The surface gloss of the broad side of the 2.25″×2.25″×0.125″ opaque black plaques (Resins 4, 5 and 6) was measured using a BYK Micro tri-gloss meter, measurement angles 20°, 60° and 85°. Gloss was measured both parallel (PAR) and perpendicular (PERP) to the orientation of the layer lines. Standard deviation (StDEV) was calculated for 5 measurements per sample.

### Results

### Reflection of Translucent Materials (Resins 1, 2, and 3). Results in Table 1.

All FFF printed resins demonstrate non-uniform % R when the layer lines are oriented horizontal vs. vertical relative to the surface upon which the spectrophotometer sits.
This result is due to the orientation of the layer lines relative to the light source. The Lambda 950 light beam has an anisotropic (rectangular) beam cross section. The reflection from the lenticular layer line pattern therefore demonstrates dependence on the orientation of the layer lines.
   It is noted that the orientation dependence of % R is also seen for lenticular light lenses prepared by profile extrusion with a similar surface patterns.
   In contrast, when Resin 1 and Resin 3 are injection molded there is no orientation dependence and the ratio is 1.00. The injection mold has a highly polished, smooth mold surface, accordingly injection molding with this mold produces plaques with smooth surfaces. Even for Resin 3 which includes PMAs, injection molding products smooth plaque surfaces.
   Amongst FFF printed Resins, the R orientation ratio is ˜50% closer to ideal (1.00) for Resins 2 and 3 compared to Resin 1. Upon visual observation, the layer lines of FFF printed Resin 1 are more noticeable than the layer lines of FFF printed Resin 2 and Resin 3. It follows that the layer lines on FFF printed resins 2 and 3 are less visible than FFF printed resin 1.

TABLE 1

| | | % R | R-Orientation Ratio |
|---|---|---|---|
| ID | Orientation | (560 nm) | (HORT/VERT) |
| Resin 1 | HORT | 23.0 | 0.94 |
| | VERT | 21.8 | |
| Resin 2 | HORT | 25.5 | 0.98 |
| | VERT | 25.0 | |
| Resin 3 | HORT | 22.9 | 1.02 |
| | VERT | 23.5 | |
| Resin 1 | HORT | 8.0 | 1.00 |
| (Injection Molded) | VERT | 8.0 | |
| Resin 3 | HORT | 7.8 | 1.00 |
| (Injection Molded) | VERT | 7.8 | |

### Reflection of Black Opaque Materials (Resins 4, 5 and 6). Results in Table 2.

All FFF printed resins demonstrate orientation dependent % R when the layer lines are oriented horizontal vs. vertical relative to the surface upon which the spectrophotometer sits.
The injection molded Resin 4 does not demonstrate orientation dependence in % R.
The % R Orientation ratio was closer to ideal (1.00) for FFF printed samples with PMAs (Resin 5 and Resin 6) compared to the sample without PMAs (Resin 4). Upon visual observation, the layer lines of FFF printed Resin 4 are more noticeable than the layer lines of FFF printed Resin 5 and Resin 6.
Additionally, the % R for Resins 5 and 6 are less than Resin 4 at all orientations. The results suggest that the layer lines on FFF printed resins 5 and 6 are less visible than those on FFF printed Resin 4.

TABLE 2

| | | | % R-Orientation |
|---|---|---|---|
| | | % R | Ratio |
| ID | Orientation | (560 nm) | (HORT/VERT) |
| Resin 4 | HORT | 3.9 | 1.42 |
| | VERT | 2.8 | |
| Resin 5 | HORT | 3.5 | 1.30 |
| | VERT | 2.7 | |
| Resin 6 | HORT | 3.6 | 1.31 |
| | VERT | 2.7 | |
| Resin 4 | HORT | 4.2 | 1.00 |
| (Injection Molded) | VERT | 4.2 | |

### Gloss Ratio of Black Opaque Materials (Resins 4, 5 and 6). Results in Table 3.

All FFF printed resins demonstrate non-uniform % R when the gloss is measured parallel vs. perpendicular relative to the layer lines.
Resin 4 prepared by injection molding does not have layer lines, and thus the gloss does not change with the direction of measurement (Surface Gloss Ratio=1.0). It is noted that the surface gloss of Resin 4-Injection molded was first measured to obtain the “Parallel Gloss” values, then rotated 90 degrees and measured perpendicular to the first measurement direction to obtain the “Perpendicular Gloss” values.
Resins with PMAs (Resins 5 and 6) have SGR much closer to 1.0 than Resin 4, over 5 times improvement. Upon visual observation, the layer lines of FFF printed Resin 4 are more noticeable than the layer lines of FFF printed Resin 5 and Resin 6. Accordingly, the layer lines of FFF printed Resins with PMAs are more difficult to perceive visually.
Resin 5 has the gloss ratio closest to ideal (1.0). It is proposed that the larger particle size of Acrylic Bead A relative to Acrylic Bead B is responsible for the improved performance

TABLE 3

| | | | | | | | Gloss Ratio |
|---|---|---|---|---|---|---|---|
| | | | | | | | (Gloss |
| | | | | | | | Parallel/ |
| | | | | | | | Gloss |
| | 20° | StDEV | 60° | StDEV | 85° | StDEV | Perpendicular) |
| Gloss Measured Parallel to Print Direction | | | | | | | |
| Resin 4 | 0.2 | 0 | 2.2 | 0 | 30.4 | 0.4 | |
| Resin 5 | 0 | 0 | 0.9 | 0 | 1.6 | 0 | |
| Resin 6 | 0 | 0 | 0.9 | 0 | 2.6 | 0.1 | |
| Gloss Measured Perpendicular to Print Direction | | | | | | | |
| Resin 4 | 0.1 | 0 | 1.2 | 0 | 2.4 | 0 | 12.7 |
| Resin 5 | 0 | 0 | 0.7 | 0 | 1.8 | 0 | 0.9 |
| Resin 6 | 0 | 0 | 0.7 | 0 | 1.7 | 0 | 1.5 |

1. A polymer composition for use in 3-D printing, wherein said composition comprises from 30 to 99.9 weight percent of a thermoplastic polymer resin matrix, and from 0.1 to 50 wt % of a polymeric matting agent.

2. The polymer composition of claim 1, wherein said composition comprises from 40 to 95 weight percent of a thermoplastic polymer resin matrix, and from 5 to 60 wt %, of a polymeric matting agent.

3. The polymer composition of claim 1, wherein said thermoplastic polymer resin matrix is selected from the group consisting of acrylonitrile-butadiene-styrene (ABS), acrylonitrile-styrene-acrylate (ASA) copolymers, styrene acrylonitrile (SAN) copolymers, polylactic acid (PLA) acrylics, glycol modified polyethylene terephthalate (PETG), polycarbonate (PC), thermoplastic polyurethane (TPU), polyamides and copolyamides, polyether-block polyamides (PEBA), polyether ether ketone (PEEK), polyether ketone ketone (PEKK), polyethylenimine (PEI), polysulfone (PSU), polyphenyl sulfone (PPSU), polyvinylidene fluoride (PVDF), polyesters, polystyrene, polypropylene and other polyolefins and copolymers, blends and alloys of these.

4. The polymeric composition of claim 3, wherein said thermoplastic polymer resin matrix is an amorphous thermoplastic polymer matrix selected from the group consisting of ABS, PMMA, PETG, ASA, PC, PLA, and PEBA.

5. The polymeric composition of claim 3, wherein said thermoplastic polymer resin matrix is PMMA.

6. The polymeric composition of claim 5, wherein the composition comprises from 0.01 to 50 weight percent of an impact modifier.

7. The polymer composition of claim 1, wherein said polymeric matting agent is selected from the group consisting of acrylic copolymers, styrenic copolymers, acrylic/styrenic copolymers, polyamides, copolyamides, polytetrafluoroethylene (PTFE), polyvinylidene fluoride (PVDF), linear and crosslinked silicones, silsesquioxane silicones obtained via hydrolysis and polycondensation of organotrialkoxysilanes, and tetraalkoxysilanes.

8. The polymer composition of claim 1, wherein said polymeric matting agent has a number average particle size as determined by laser diffraction particle size analysis of from 0.3 to 200 micrometers.

9. The polymer composition of claim 1, wherein said composition further comprises from 0 to 40 weight percent of one or more additives selected from the group consisting of impact modifiers, lubricants, dispersion agents, UV stabilizers, and colorants.

10. Use of a polymer composition comprising from 30 to 99.9 weight percent of a thermoplastic polymer resin matrix, and 0.1 to 50 wt % of a polymeric matting agent in 3-D printing.

11. Use of the polymer composition according to claim 1, in 3-D printing.

12. A 3D printed article, wherein said article comprises two or more different domains of thermoplastic material, wherein said domains are present in the bulk of the article, and wherein said domains are also present on the surface of the printed object, where at least one of the domains is the polymer composition of claim 1.

13. The 3-D printed article of claim 12, wherein said article comprises 30 to 99.9 weight percent of at least one thermoplastic as the matrix, and from 0.01 to 50 weight percent polymer matting agent, wherein said 3-D printed article has a surface gloss ratio (SGR) of from 0.5 to 10.0 as measured on a 3-D printed article without any additional post-printing treatment.

14. A 3D printed article comprising the polymer composition according to claim 1, wherein said 3-D printed article has a surface gloss ratio (SGR) of from 0.5 to 10.0 as measured on a 3-D printed article without any additional post-printing treatment.

15. The 3-D printed article of claim 12, wherein said article comprises 30 to 99.9 weight percent of at least one thermoplastic as the matrix, and from 0.01 to 50 polymer matting agent, wherein said 3-D printed article has a Reflectance ratio (R) of from 0.95 to 1.05 as measured on a 3-D printed article without any additional post-printing treatment.

16. A 3D printed article comprising the polymer composition according to claim 1, wherein said 3-D printed article has a Reflectance ratio (R) of from 0.95 to 1.05 as measured on a 3-D printed article without any additional post-printing treatment.

17. The 3D printed article of claim 12, wherein said article is selected from the group consisting of an automotive article, building article, construction article, capstock, aeronautic article, aerospace article, photovoltaic article, medical article, computer-related article, telecommunication article, and wind energy article.

18. The article of claim 12, wherein said article is selected from the group consisting of exterior paneling, automotive body panels, auto body trim, recreational vehicle body panels and trims, exterior panels for recreational sporting equipment, marine equipment, exterior panels for outdoor lawn, garden and agricultural equipment and exterior paneling for marine, aerospace structures, aircraft, public transportation applications, interior paneling applications, interior automotive trims, components for head and or tail lights on vehicles, prototyping, interior panels for marine equipment, interior panels for aerospace and aircraft, interior panels for public transportation applications, and paneling for appliances, furniture, and cabinets, recreational vehicle, sporting equipment, marine, aerospace, decking, railing, siding, window and door profiles, dishwasher and dryers, refrigerator and freezers, appliance housing or doors, bathtubs, shower stalls, spas, counters, and storage facilities, decorative exterior trim, molding side trim, quarter panel trim panels, fender and fender extensions, louvers, rear end panels, caps for pickup truck back, rearview mirror housings, accessories for trucks, buses, campers, vans, and mass transit vehicles, b pillar extensions, and the like; appliances and tools such as lawn and garden implements, bathroom fixtures for mobile homes, fencing, components of pleasure boats, exterior components of mobile homes, lawn furniture such as chair and table frames, pipe and pipe end caps, luggage, shower stalls for mobile homes, toilet seats, signs, spas, air conditioner and heat pump components, kitchen housewares, bead molded picnic coolers, picnic trays and jugs, and trash cans; venetian blind components; sporting goods such as sailboards, sailboats; plumbing parts such as lavatory parts and the like; construction components, in addition to those mentioned previously, the additional components including architectural moldings, door molding, louvers, and shutters, mobile home skirting, residential or commercial doors, siding accessories, window cladding, storm window frames, skylight frames, end caps for gutters, awnings, car port roofs, lamp, lighting equipment, sensor, custom carry cash for consumer items, silverware, trim for cars, prototypes, figurines, dentures, hardware, cabinet, ball-joint, hosing, glasses, cage, UV protector screen, signage, toys, medical equipment such as implants and equipment components, lighting appliques, luminaire housing, window coverings, surface modification, visualization aids 3D model based on, medical imaging, architectural models, topographic data, mathematical analysis, or other data sets. Education aids, props, costumes, park benches, robotics components, electrical enclosures, 3D printer components, jigs, fixtures, manufacturing aids, molds, sculptures, statues, board games, miniatures, dioramas, trophies, drones, UAV's, medical devices (Class I, Class II, and Class Ill according to FDA Code of Federal regulations Title 21), diffuser or light diffusing elements, instrumentation, solar cells, fixtures and rigging for solar power generating systems, artificial nails, dosimeters, jewelry, footwear, fabric, firearm components, cell phone cases, and packaging.

19. A process for the Material Extrusion 3D printing of a composition, comprising the steps of:
a) feeding a material comprising the polymer composition of claim 1 into a 3D printer,
b) passing the polymer composition through a heated nozzle at the conditions controlled by a computer,
c) depositing a set amount of the polymer composition through the nozzle at a set position in relation to the article to be printed, and
d) cooling the printed article.

20. The process of claim 19, wherein the polymer composition comprises from 40 to 95 weight percent of a thermoplastic polymer resin matrix, and from 5 to 60 weight percent of a polymeric matting agent.

21. The process of claim 19, comprising multiple nozzles capable of each printing different compositions, wherein each composition comprises either different matting agents, different concentrations of matting agents, or both.

22. The process of claim 19, wherein two or more different polymer compositions are combined in the 3D printer.
